(19) United States
(12) Patent Application Publication
(10) Pub. No.: US 2011/0029276 A1
(43) Pub. Date: Feb. 3, 2011

(54) SYSTEM AND PROCEDURE FOR THE REAL-TIME MONITORING OF FIXED OR MOBILE RIGID STRUCTURES SUCH AS BUILDING STRUCTURES, AIRCRAFT, SHIPS AND/OR THE LIKE

(75) Inventor: Miguel Luis Cabral Martin, Las Palmas de Gran Canaria (ES)

Correspondence Address: LUCAS & MERCANTI, LLP, 475 PARK AVENUE SOUTH, 15TH FLOOR, NEW YORK, NY, 10016, US

(73) Assignee: STRUCTURAL DATA, S.L., Las Palmas de Gran Canaria (ES)

(21) Appl. No.: 12/936,051

(22) PCT Filed: Apr. 1, 2008
(86) PCT No.: PCT/EP08/02562

§ 371 Date: Oct. 1, 2010

(51) Int. Cl. G01P 15/00; G01C 9/00

(52) U.S. Cl. 702/141; 702/154

(57) ABSTRACT

This invention relates to a system and a procedure for the carrying out of the ongoing monitoring in time of the distortions in a stationary or moving structure, due to the various effects acting thereupon, such as frictional forces, forces produced by loads, resistance forces, etc. The disturbances exerted on a structure may cause distortions, which may be calculated by using the warp and twist angles. When the disturbance acts on the structure for a period of time, these measured values may be used by a processor integrated in the system which, by means of mathematical analysis, will determine the necessary parameters, such as resistance, fatigue, acceleration, elastic potential energy, direction of the forces, speed, elasticity, etc., in order to determine the state of the structure and to establish its useful life span. The system and procedure are comprised of a plurality of inclinometers (2), at least one gyroscope (3) and a plurality of accelerometers (4), uniformly or otherwise distributed throughout the structure to be monitored. This allows the structure to be divided into sections, and all the information reflected by these measurements is transmitted to a processor (5).

### SECTOR OF THE ART

This invention corresponds to the field of mechanics and of the resistance of materials; said invention relates to a system and a procedure for the determining of parameters which are essential for dynamic structural analysis and its monitoring in real time.

### STATE OF THE ART

The object of the invention relates, as is mentioned in the title of the specification, to a device and to a procedure which allows the taking of measurements of the essential parameters for the real-time analysis of dynamic structures, fundamentally using the flection angles and/or transversal and longitudinal twist angles of a structure as the basic variables, also known as warp and twist angles; i.e. the lateral or horizontal warp angle, said structure being fixed or mobile; by means of said system and procedure it is intended to determine the basic parameters of the status of a structure, such as resistance, fatigue, the resulting distortion, kinetic and potential energy, force vector direction, speed, acceleration, etc. in real time, in order that decisions and corrective actions may be taken at the moment when certain parameters approach maximum distortion values and thus prevent breakages in the structure to be monitored, in addition to the dynamic monitoring of the structure.

One objective of this invention is to find out, with a high degree of accuracy, of the progression and of the consequences presented by the distortion of a structure over time, which would enable us to know the time span of the useful life of the structure, and also the most sensitive zones of the structure.

Another objective of this invention is to provide a system and a method which may be used by the manufacturers and designers of structures in order to develop safer and more reliable constitutive elements or parts for various applications when carrying out the various resistance tests.

There exists a Spanish patent no. ES2242474, with presentation date Dec. 2, 2002, which discloses a test system for the fatigue of components of great length, which features an exciter which simulates a force which is variable in time, which is comprised of two clamps which are adaptable to any position along the example to be tested, a reducing motor capable of providing the necessary torque and a pendulum prepared for varying the excitation by means of the addition or relocation of weights therewithin; means for modifying the mass distribution of the example to be tested, by means of the placement of clamps at different sections, these being weight-adjustable due to the possibility of placing weights thereupon; a test controller comprised of a reducing motor, a frequency selector and an accelerometer which form a closed loop system, coordinated by a software program and a data logging system for comparing the reading in real time.

As may be observed, this system uses a comparative force which simulates a force which is variable in time, and a pendulum which allows the measurement of the bending moment applied over the length of a blade with the reading of the callipers placed at the different monitoring sections, for the measurement of twist torque. This case may be of great use for the calibration of elements to be designed; in the case of this invention it is a system which combines different measuring elements such as: gyroscopes, accelerometers, inclinometers, all of these connected to the structure to be monitored in order to carry out an “in situ” measurement and to process said measurement, so that by using the warp and twist angles, the necessary parameters for the analysis of the structure may be determined with great accuracy.

The patent WO 2008/003546 discloses a method for monitoring the condition of the components of a structure wherein the image of the structure is produced by means of an optic sensor; said image is transmitted to a processor and the image is compared with an image of reference; the geometrical deviation obtained between said images allows the distortion presented by the structure to be determined. As may be observed, this is a method which does not allow for a direct quantitative measurement to be made, but is the comparison of the images obtained. However, this is not as sufficiently precise as the obtaining of characteristic parameters such as the highly precise comparison of the measurement of warp and twist angles over short intervals of time.

The British International Priority Application WO 2007/104915 portrays a system for the monitoring of a structure by elongation, where said system comprises an optic fibre cable housed along said structure, a system coupled to the optic fibre cable and calibrated with a backscattering thickness gauge, coherent with Rayleight scattering or the Raman Effect. As may be observed, it presents a different technique, as it uses optical devices in order to achieve a comparison which allows it to determine the structural changes due to the distortion.

The American International Priority Application WO 2007/059026, which presents a system comprising a structure, from 1 to 10 dynamic tension sensors, adapted to monitor a dynamic tension level of at least one point along a length of the structure, and a controller adapted to calculate a dynamic bending stress or strain level at a plurality of points along the length of the structure as a function of time. It also comprises a number of vessels connected to the structure, wherein the vessels are floating in a body of water.

As may be observed in the prior art, the majority of the techniques used for the monitoring of structures are based on the use of optic means, by the comparison of images or by electronic and magnetic means. In none of these cases is a real-time measurement of the warp and twist angles carried out, regardless of whether the structure is considered to be fixed, such as construction elements, bridges, buildings, or for mobile structures such as ships, aircraft, trains; for this reason the system and the procedure proposed by this invention provide a technique whose assessment is carried out based on exact, concrete calculations, obtained by the use of suitable means, regardless of whether the structure to be monitored is stationary or moving.

### DESCRIPTION OF THE DRAWINGS

FIG. 1 is an example of an embodiment where an exploded view of the system applied to the various separate structures of an aircraft is portrayed

FIG. 2 is an example where a view of the complete system, applied to a complete aircraft, is portrayed

FIG. 3 is an example of an embodiment applied to a ship, where an external view of the ship, with the elements of the system, is portrayed

FIG. 4 is an example of an embodiment applied to a ship, where the base plan thereof is portrayed, with the various elements of the system

FIG. 5 portrays a perspective view of the system applied to the example of the ship

FIG. 6 portrays the static distortion presented by the structure (1) where the distortion with regard to the tangent at a preferred point may be observed

FIG. 7 portrays the distortion of the structure (1) due to the dynamic effect, and the new distortion angles with regard to the tangent

FIG. 8 portrays the warp inertia angle with regard to the inclinometer and to the gyroscope when a disturbance occurs

FIG. 9 portrays the length of the inertia arc when a disturbance occurs

FIG. 10 portrays the variation in height of the arm of the inclinometer with regard to its original height, subsequent to the disturbance

FIG. 11 portrays the twist angle of a structure with regard to the horizontal or the twist inertia angle

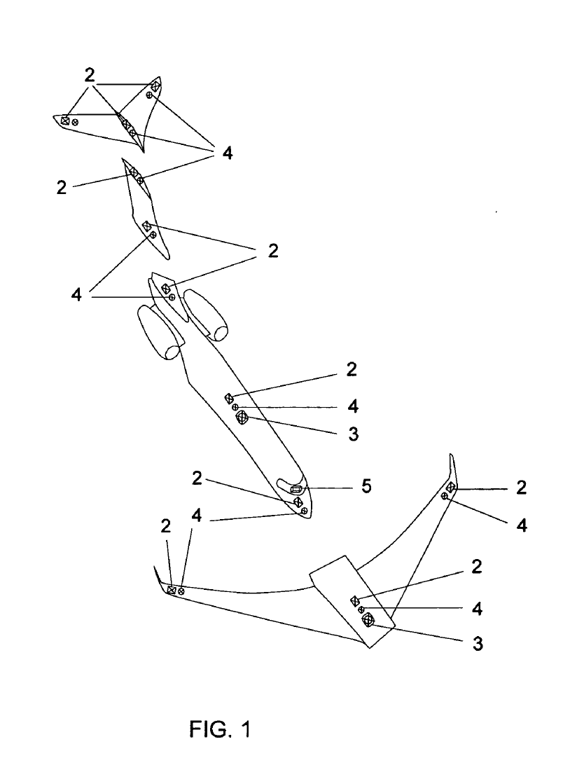

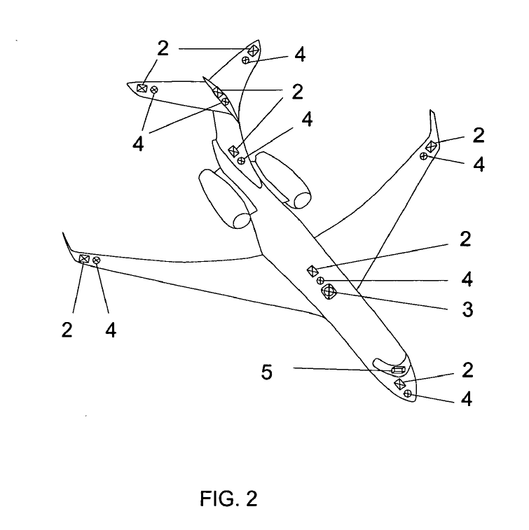

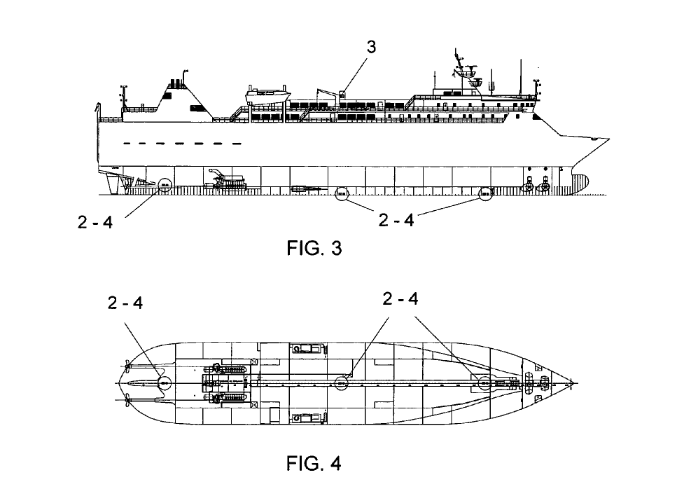

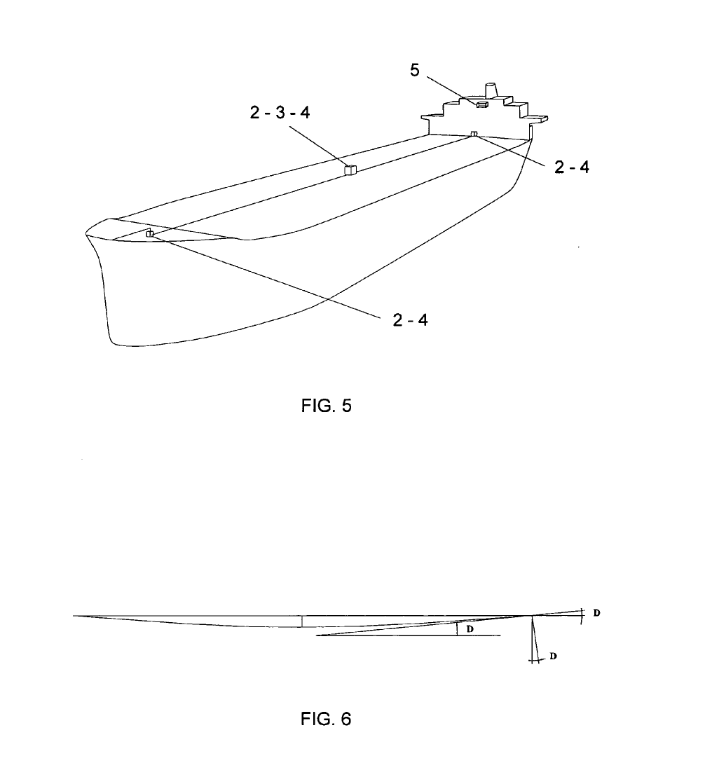

### DETAILED DESCRIPTION OF THE INVENTION

This invention relates to a system and a procedure for the carrying out of the ongoing monitoring in time of the distortions in a stationary or moving structure, due to the various effects acting thereupon, such as frictional forces, forces produced by loads, resistance forces, etc. The disturbances exerted on a structure may cause distortions, which may be calculated by using the warp and twist angles. When the disturbance acts on the structure for a period of time, these measured values may be used by a processor integrated in the system, which, by means of mathematical analysis, will determine the necessary parameters, such as resistance, fatigue, acceleration, elastic potential energy, direction of the forces, speed, elasticity, etc., in order to determine the state of the structure and to find out its useful life span.

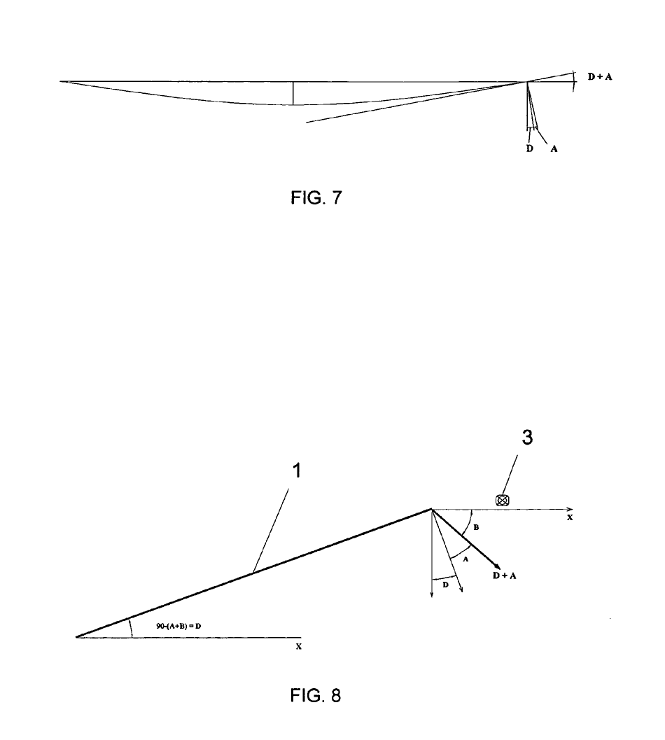

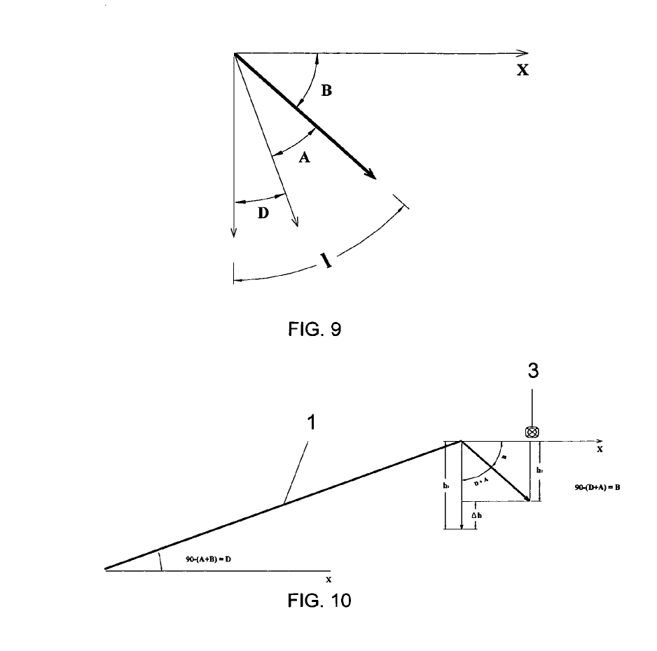

The system of this invention is comprised of a plurality of inclinometers (2) housed in the body of the structure (1), preferably uniformly distributed. The inclinometers (2) enable the measurement of the angle (A) formed by the hanging arm and a perpendicular traversing the end of the structure (1) (FIGS. 7, 8). At the moment when there is a disturbance which exerts stress on said structure (1), the gyroscope (3) enables us to measure the angle (D) formed by the structure (1) with the artificial horizon (x-axis) (FIG. 8). As is well known, there is a static distortion of the structure (1) prior to the disturbance, as may be observed (FIG. 6), where the static distortion angle of the structure (1) with regard to the tangent at the end is equivalent to that measured by the gyroscope (3). For this reason, the sum of the angles (D) and (A) subsequent to the distortion enable us to obtain a measurement of the angle exerted by the inertia applied at the point where it is desired to take the measurement. This is equivalent to the angle formed by the tangent to the distorted surface of the structure at the point where the measurement is taken, this being the angle of maximum elastic potential energy due to the warp (FIG. 8). The angle (D) is exactly the same as that formed by the structure (1) with the horizontal at the moment of warping. For this reason we use the gyroscope (3), which bases its measurements using a horizon. The difference between 90 degrees and the sum of the angles determined in (A) and (D) allow the determining of the angle (B) (FIG. 8) with regard to the artificial horizon. The length of the inertia arc (I) produced by the inertia (FIG. 10) may be determined by using the height of the arm (h−i) and the angle of inertia (D+A). These measurements also allow the calculation of the variation in height (Δh) when the arm of the inclinometer has moved to a height (h₂) with regard to the initial height of the inclinometer (h−i), thus determining the elastic potential energy associated with the disturbance. On the other hand, any variation in height (Δh) with regard to the initial height of the arm (hi) lingering in time, indicates that there is a distortion by bending with regard to the initial situation (h−i) (FIG. 10). With regard to longitudinal distortions (lateral and/or horizontal), the measurements of the accelerometers (4) are used; these measurements may be taken as the initial measuring pattern before any disturbance. When a disturbance occurs, the relative position of the accelerometers (4) changes, where said change is reflected in a variation both in length and in the distortion angle of the structure (1) over time. As the inclinometers (2) and accelerometers (4) are distributed throughout the structure (1), this allows us to determine exactly those regions in the structure where distortion occurs, all of this measured in real time, as the system features a means of data transfer to a processor (5) which features continuous time measurement and determines, by means of the data emitted by the inclinometers (2), the gyroscope (3) and the accelerometers (4), all the physical quantities necessary for the correct monitoring of the structure (1), these being: fatigue, resistance, elastic potential energy, elasticity, vector force direction, speed of the disturbance, acceleration, etc. The system also enables the determining of the distortions which may occur due to the effect of twisting when a disturbance occurs. Normally the effects of twisting have been deemed to be negligible, but on some occasions these effects, particularly in devices which are habitually moving, such as aircraft, ships, trains, etc., subjected to different frictional forces due to the environment, may be of great importance in order to identify a significant structural distortion and a possible breakage of said structure.

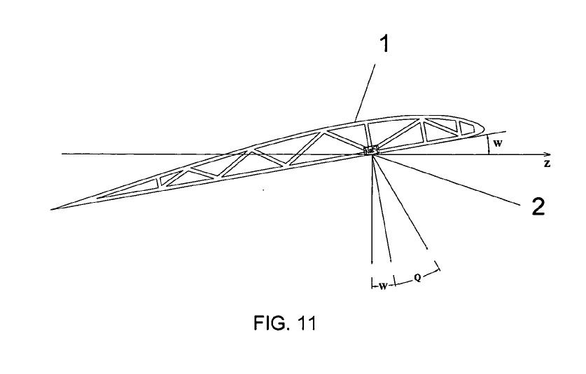

The gyroscope (3) determines the transversal slope angle (W) with regard to an artificial horizon (z-axis) which is transversal to the structure, and the inclinometer (2) measures the transversal slope angle (Q) with regard to an initial position where there is no disturbance, i.e. with regard to an initial position of the arm of the inclinometer regarding the norm at the point of twisting. The sum of angles (W) and (Q) (FIG. 11) indicates the total angle due to the twist inertia; it is evident that by means of both angles, the remainders of the parameters are determined; these allow the assessment of the effects of the distortion due to twisting: fatigue, resistance, elasticity, elastic potential energy, vector force direction, speed, etc.

The system and the procedure of this invention comprises a plurality of inclinometers (2), at least one gyroscope (3) and a plurality of accelerometers (4), uniformly or otherwise distributed throughout the structure to be monitored. This allows the structure to be divided into sections, which can indicate to us those regions where the effect caused by the various distortions may be observed. All the information reflected by these measurements is processed by a processor (5) which may be a computer, which features continuous time measurement; this enables the drawing up of a graph of the distortions throughout the structure over time, and thus obtaining the resulting fatigue and distortion with considerable accuracy, as well as other parameters which are important for the structural study.

The procedure used by the system for its start-up and for the processing of the information coming from the inclinometers (2), gyroscope (3) and accelerometers (4) would consist of first setting all the instruments at the same level of uniformity and tare; i.e. setting the device (all the instruments) so that it will not surpass a preset limit; all the instruments must therefore display the same reading (or the real measurement of that part of the structure, depending on the type of uniformity or tare); this will be the reference point for future measurements. At this point, the processor (5) is activated, and it receives information for an initial period of time. When the structure receives a disturbance, the inclinometers (2) display a measurement of the slope angle (A) of the arm with regard to the reference measurement. This information is transmitted to the processor (5); at the same time, the gyroscope (3) displays a measurement of the angle (D) with regard to the horizontal, which is transmitted to the processor (5). Also at the same time, the accelerometers (4) measure their displacement from their initial position, and said measurement is transmitted to the processor (5). The processor (5) will determine the total warp angle by adding the angles (A) and (D) measured; the processor (5) will determine the height (h₂) reached by the arm of the inclinometers (2), and by applying the appropriate equations will determine the difference between the initial and final heights (Δh) of the arm of the inclinometers (2). The processor (5) will also determine the movement, both longitudinal and angular, of the accelerometers (3) with regard to their initial position of reference, and by means of an appropriate software, the processor (5) will carry out the determination of the essential parameters for the calculation of fatigue, resistance, effect of the loads, elasticity, elastic potential energy, speed, kinetic energy, mechanical energy, force vector direction, distortion, etc., by using the necessary mechanical equations, each of these being in real time, indicated by the processor (5). Said processor (5) will draw up graphs of each of these parameters with regard to time, due to the effects of the warp. (In the event that the angle D+A, corresponding to the inertia force vector at that point, is not perpendicular to the Tg which determines the angle of rotation and/or the inertial distortion by warping, the correction thereof, as well as being executed with the accelerometers may also be carried out by means of inertial and/or gyroscopic inclinometers.)

The procedure of the system, as has been mentioned above, also involves the effects of twisting on the structure (1); initially, the measuring devices, these being the inclinometers (2) and the gyroscope (3), will be at an initial reference point; the gyroscope (3) carries out a measurement of the transversal slope angle (W) with regard to an artificial horizon which traverses the structure (1). This information is transmitted to the processor (5). At the same time, the inclinometer (2) takes a measurement of the transversal slope angle (Q) with regard to an initial position wherein there is no disturbance; this is the initial position of the arm of the inclinometer with regard to the norm at the point of the twist. This signal is transmitted to the processor (5). The processor (5) adds angles (W) and (Q), and this result enables the processor (5), by means of appropriate software, to carry out calculation operations by means of mechanical equations, thus determining: fatigue, resistance, effect of the loads, elasticity, elastic potential energy, speed, kinetic energy, mechanical energy, force vector direction, distortion, etc. Due to the effects of twisting on the structure over different time intervals, these will be used by the processor (5) to execute comparative graphs in accordance with the time of the distortions in the structure. (In the event that the angle W+Q, corresponding to the inertia force vector at that point, is not perpendicular to the Tg which determines the angle of rotation and/or the inertial distortion by twisting, the correction thereof, as well as being executed with the accelerometers may also be carried out by means of inertial and/or gyroscopic inclinometers.)

1. System for real-time monitoring of fixed or mobile rigid structures, wherein a rigid structure is subjected to warping and twisting forces, said system comprising the following elements: a plurality of hanging inclinometers distributed throughout the structure; at least one biaxial gyroscope, which may also function as an inclinometer or independently from a remainder of the inclinometers, located at one place in the structure; a plurality of accelerometers housed throughout the structure, each means to enable a transmission of and readings from the inclinometers, each gyroscope and the accelerometers; and at least one processor of information, said processor featuring continuous time measurement.

2. System for the real-time monitoring of fixed or mobile rigid structures, according to claim 1, wherein the inclinometers determine a slope angle of an arm of said inclinometer, with regard to a position of reference at rest on the structure to be measured, due to a disturbance by warping in said structure.

3. System for the real-time monitoring of fixed or mobile rigid structures, according to claim 1, wherein the gyroscope allows taking of measurements of a warp angle of the structure with regard to a horizontal whenever a disturbance occurs in the structure to be monitored.

4. System for the real-time monitoring of fixed or mobile rigid structures, according to claim 1, wherein a difference between 90 degrees and a sum of a warp angles determined by the inclinometer and the gyroscope determine an angle of an arm of the inclinometer with regard to a vertical.

5. System for the real-time monitoring of fixed or mobile rigid structures, according to claim 1, wherein the accelerometers perform a relative movement between each other due to a disturbance, with regard to their non-disturbed initial position.

6. System for the real-time monitoring of fixed or mobile rigid structures, according to claim 1, wherein the gyroscope measures a transversal slope angle of the structure due to a twisting movement resulting from a disturbance with regard to a transversal horizon.

7. System for the real-time monitoring of fixed or mobile rigid structures, according to claim 1, wherein the inclinometer measures a transversal slope angle with regard to a non-disturbed position due to a twisting movement resulting from a disturbance.

8. System for the real-time monitoring of fixed or mobile rigid structures, according to claim 1, wherein it features the following stages for the measurement of a warp disturbance; setting all the instruments at a same level of uniformity and tare; reading the inclinometers, the gyroscope, the accelerometers; transmitting, with appropriate means, the information to the processor, the processor receives the information for an initial period of time, when the structure receives a disturbance, the inclinometers display a reading of a slope angle of the arm with regard to the reference measurement, and the information is transmitted to the processor at a same time, the gyroscope displays a reading of an angle with regard to a horizontal, which is transmitted to the processor also at the same time, the accelerometers measure a displacement from an initial position, and said reading is transmitted to the processor, the processor determines a total warp angle by adding the angles and measured, the processor determines a height reached by an arm of the inclinometers and will determine the difference between initial and final heights of the arm of the inclinometers the processor will carry out the determining of the essential parameters for a calculation of fatigue, resistance, effect of the loads, elasticity, elastic potential energy, speed, kinetic energy, mechanical energy, force vector direction, distortion, etc., the processor will draw up graphs of each of these parameters with regard to time, due to the effects of the warp. the processor will draw up graphs of the distortions by warping throughout the structure for a particular time.

9. System for the real-time monitoring of fixed or mobile rigid structures, according to claim 6, featuring the following stages for a twisting disturbance: determining a reading of the gyroscope and the inclinometers as a reference point, the processor receives information from the gyroscope and the inclinometers for an initial period of time the gyroscope carries out a measurement of the transversal slope angle with regard to an artificial horizon which traverses the structure subsequent to the twisting disturbance; the information is transmitted to the processor at the same time, the inclinometer carries out a measurement of a transversal slope angle when there is a disturbance with regard to an initial non-disturbed position, and the signal is transmitted to the processor the processor adds the angles from the gyroscope and the inclinometers, by means of an appropriate software, the processor carries out the calculation operations, thus determining: fatigue, resistance, effect of the loads, elasticity, elastic potential energy, speed, kinetic energy, mechanical energy, force vector direction, distortion, etc. using these results, the processor will draw up comparative graphs according to the time of each twist parameter with regard to time and the processor draws up graphs of the distortions by twisting throughout the structure for a particular time.

10. System for the real-time monitoring of fixed or mobile rigid structures, wherein the inclinometers are uniformly distributed.

11. System for the real-time monitoring of fixed or mobile rigid structures, wherein the gyroscope is located in the center of the structure.
